(19) United States
(12) Patent Application Publication
(10) Pub. No.: US 2008/0079275 A1
(43) Pub. Date: Apr. 3, 2008

(54) APPARATUS AND METHOD FOR EFFECTIVELY REMOVING ANIMAL WASTE

(76) Inventor: Meir Avigdor, New York, NY (US)

Correspondence Address: Avi Outmezguine;Apt. 2, 238 6th Avenue, Brooklyn, NY, 11215, US

(21) Appl. No.: 11/536,567

(22) Filed: Sep. 28, 2006

(51) Int. Cl. A01K 29/00

(52) U.S. Cl. 294/1.4

(57) ABSTRACT

The present invention discloses an effective way of cleaning tip animal waste. More particularly, the present invention discloses a compact device which allows a user to dispose of animal waste through a simple two-step process utilizing a device composed of an upper section containing a levers a telescoping midsection, and a lower section containing grippers fitted with a removable bag.

### CROSS-REFERENCE TO RELATED APPLICATIONS

This application claims the benefit of U.S. Provisional Application Ser. No. 60/25,580, filed Oct. 11, 2005, the content of which is incorporated it its entire herein.

### FIELD OF THE INVENTION

The following invention discloses an effective way of cleaning up animal waste. More particularly, the present invention discloses a compact device which allows a user to dispose of animal waste through a simple two-step process.

### BACKGROUND OF THE INVENTION

There currently exist many different systems and methods for removing animal waste which is a requirement in most cities. Most often, a person utilizes a simple plastic bag or other simple method of removing the animal waste. However, this method is often messy and does not always effectively remove all of the animal waste.

Different devices, such as a Pooper Scooper, do exist for making animal waste removal slightly faster and easier. These devices are usually either bags or shovels located on a stick which can be used to pick up and remove the animal waste from a distance. However, these devices can also be messy because they are often improperly used or become dirty during use.

Therefore, there clearly exists a need for an improved animal waste removal system which allows a user to effectively remove animal waste from a distance without necessitating any further cleanup.

### SUMMARY OF THE INVENTION

The apparatus of the present invention is formed of a an upper portion which contains a lever which functions as a gripping mechanism, a telescoping midsection, and a lower portion which contains a removable bag for picking up animal waste.

The lower portion of the device is composed of two generally u-shaped portions over which the two sides of a disposable bag may be slipped. The device is constructed in such a way that by gripping and releasing the lever located on the upper portion of the device, the bag is opened and closed, respectively. The u-shaped construction of the lower portion of the device allows the bags to easily be removed and/or replaced.

To utilize the present invention, the user first extends the device to the desired length utilizing the telescoping midsection. By doing so, the user is able to increase the distance between themselves and the animal waste which is to be disposed of. Additionally, this may aid the user if he/she has back problems or other similar medical ailments.

After the user has extended the telescoping midsection, the user grips the level located on the upper portion of the device causing the removable hag to be opened. The user then places the opened bag over the animal excrement and releases the handle, causing the animal waste to be safely contained within the bag.

The user can then dispose of the waste by locating a garbage can and turning the device, thereby allowing the bag to slip off of the lower portion of the device and into the garbage. The weight of the added animal waste is what ensures that the bag will slip off with minimal user intervention.

Other objects, features, and characteristics of the present invention, as well as the methods of operation and functions of the related elements of the structure, and the combination of parts and economies of manufacture, will become more apparent upon consideration of the following detailed description with reference to the accompanying drawings, all of which form a part of this specification.

### BRIEF DESCRIPTION OF THE DRAWINGS

For a more complete understanding of the present invention, reference is now made to the following drawings in which:

FIG. 1 depicts a schematic diagram of an exemplary embodiment of the waste removal apparatus of the present invention.

FIG. 2 depicts the waste removal apparatus of FIG, 1 fully extended.

FIG. 3 depicts the lower section of the waste removal apparatus of FIG. 1 in an open position

FIG. 4 depicts the lower section of the waste removal apparatus FIG. 1 in another open position.

FIG. 5 depicts the lower section of the waste removal apparatus of FIG. 1 in a closed position.

FIG. 6 depicts the lower section of the waste removal apparatus of FIG. 1 being used to dispose of animal waste 111.

### DETAILED DESCRIPTION OF THE INVENTION

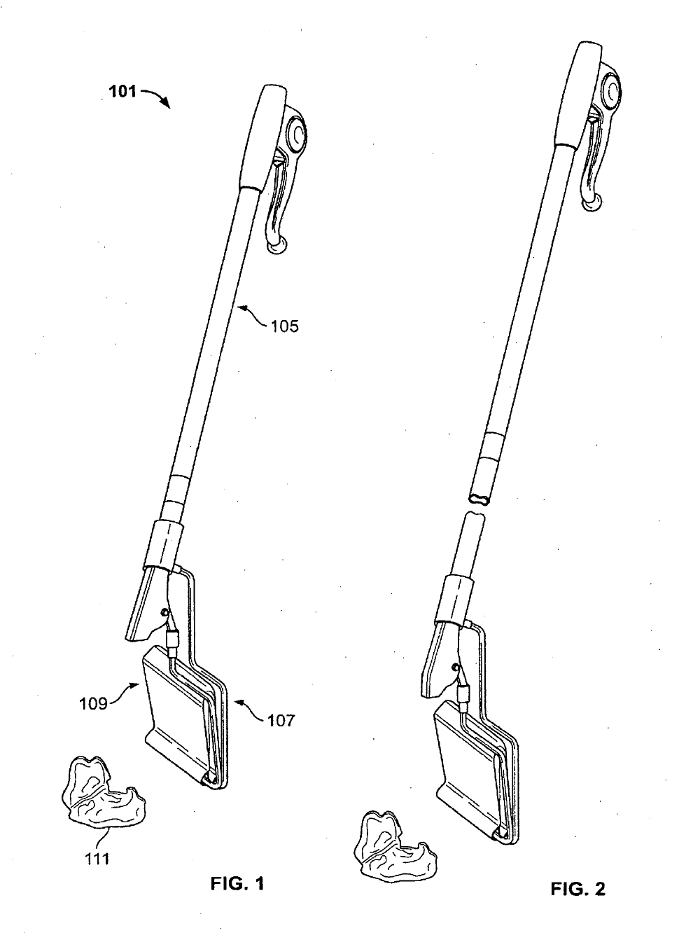

Referring first two FIG. 1 shown is a schematic diagram of an exemplary embodiment of the present invention. As shown, the waste removal apparatus 101 is formed of a an upper portion which contains a lever 103 which functions as a gripping mechanism, a telescoping midsection 105, and a lower portion which contains grippers 107 and removable bag 109 for picking up animal waste 111. Preferably, lever 103 is spring controlled such that when a user lets go of lever 103 it returns to its unaltered position.

The lower portion of the device is composed of two generally u-shaped grippers 107 over which the two sides of removable bag 109 may be slipped. The device is constructed in such a way that by gripping lever 104 and releasing it removable bag 109 is opened and closed, respectively. The u-shaped construction of the grippers 107 allows the bags to easily be removed and/or replaced.

To utilize the present invention, the user first extends the device to the desired length utilizing telescoping midsection 105 as shown in FIG. 2. By doing so, the user is able to increase the distance between themselves and the animal waste 111 which is to be disposed of Additionally, this may aid the user if he/she has back problems or other similar medical ailments.

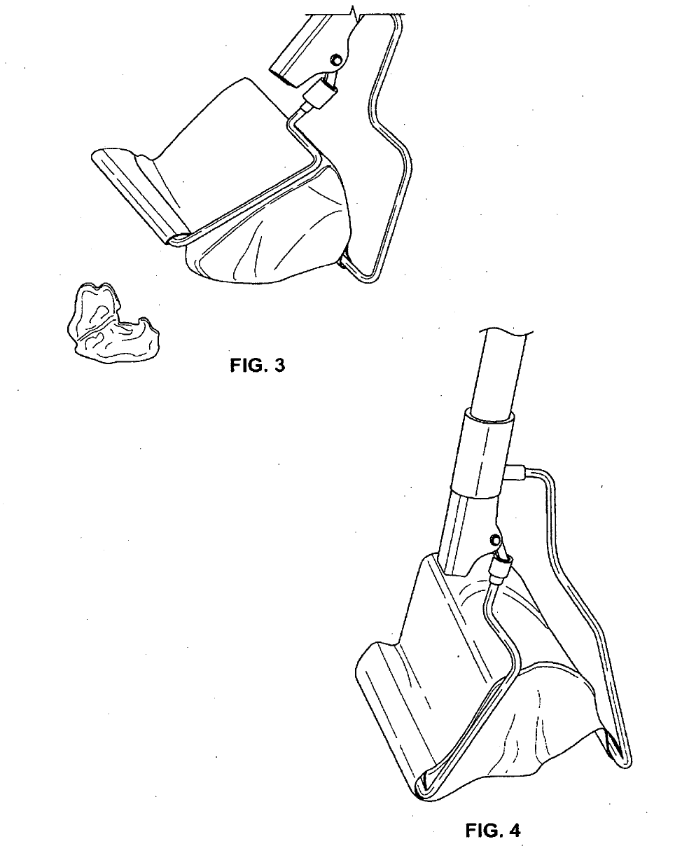

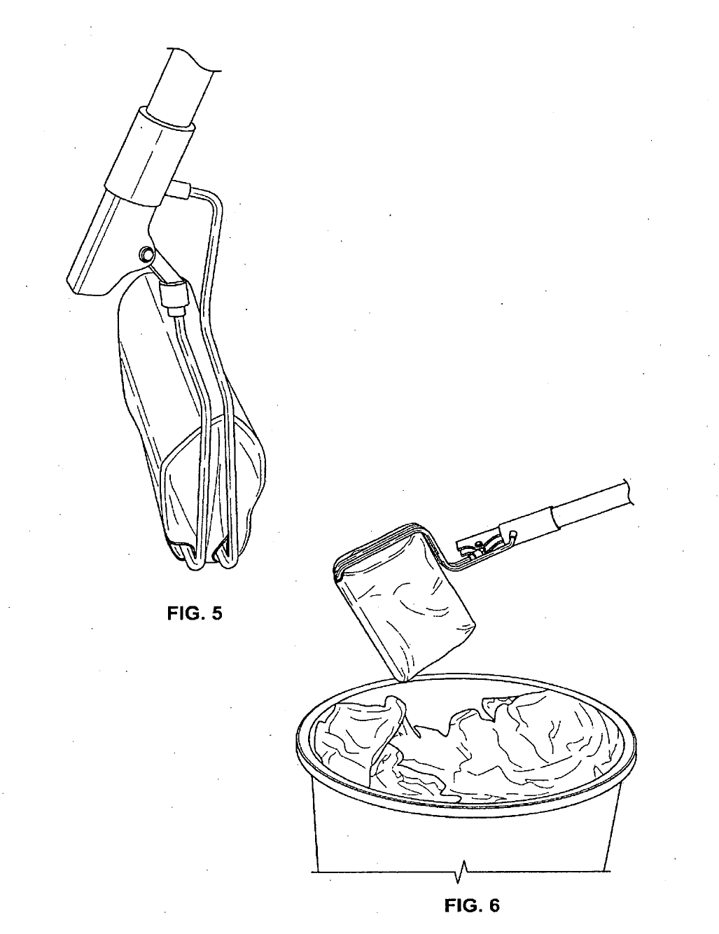

After the user has extended telescoping midsection 105, the user squeezes lever 103 thereby causing grippers 107 to open removable bag 109 as shown in FIG. 3. The user then places opened removable bag 109 over the animal waste 111 as shown in FIG. 4 and releases lever 103, causing animal waste 111 to be safely contained within removable bag 109 as shown in FIG. 5.

The user can then dispose of the waste by locating a garbage can and turning the device as depicted in FIG. 6, thereby allowing the weight of animal waste, 111 to slip removable bag 109 off of grippers 107 into the garbage can. This ensures that the user does not have to interact with the animal waste anytime during the operating of device 101.

While the present invention has been described with reference to one or more preferred embodiments, which embodiments have been set forth in considerable detail for the purpose of making a complete disclosure of the invention, such embodiments are merely exemplary and are not intended to be limiting or represent an exhaustive enumeration of all aspects of the invention. The scope of the invention, therefore, shall be defined solely by the following claims. Further, it will be apparent to those of skill in the art that numerous changes may be made in such details without departing from the spirit and the principles of the invention.

1. An apparatus for removing animal waste comprising:
a telescoping midsection;
a gripper section composed of two u-shaped hooks which are located at a bottom end of said midsection;
a removable bag placed over said gripper section;
a lever for opening and closing said u-shaped hooks which is located at the top end of said midsection;
wherein lever is able to control said gripper section by squeezing said lever; and
wherein said apparatus may be utilized for animal waste removal by squeezing said levers placing said removable bag over said animal waste, releasing said lever, placing said gripper section over a garbage can, and turning said apparatus such that said removable bag slides off said apparatus into said garbage can.
